(19) United States
(12) Patent Application Publication
(10) Pub. No.: US 2024/0226940 A1
(43) Pub. Date: Jul. 11, 2024

(54) MULTIFUNCTIONAL SHOWER

(71) Applicant: Xiamen Prime Shower Co.,Ltd., Xiamen (CN)

(72) Inventors: Yongliang DENG, Xiamen (CN); Jing GUO, Xiamen (CN); Pingxia XU, Xiamen (CN); Haibo HONG, Xiamen (CN); Qin YU, Xiamen (CN)

(21) Appl. No.: 18/614,164

(22) Filed: Mar. 22, 2024

(51) Int. Cl. B05B 12/00; B05B 1/16; B05B 1/18

(52) U.S. Cl. CPC B05B 12/002; B05B 1/1663; B05B 1/185

(57) ABSTRACT

The application discloses a multifunctional shower. A water inflow channel is formed in a shower body, and a spray nozzle is disposed on the shower body. A water outflow panel is mounted on the shower body. A diverter valve controls the water inflow channel to communicate with a spray lance water outflow cavity or a shower water outflow cavity. A movable ceramic disc of a flow adjustment mechanism is rotatable, and a toggle bar is connected to the movable ceramic disc and a push button that is disposed an outside of the shower body. The water outflow flow of the shower can be adjusted by pushing the push button. The shower has a shower water outflow function, a flow adjustment function and a spray lance water outflow function.

### TECHNICAL FIELD

The present application relates to the technical field of bathing, and in particular relates to a multifunctional shower.

### BACKGROUND

The shower is a common showering apparatus in the bathroom, and its use functions are increasingly diversified, for example, to meet the requirements of bathers for different water outflow effects. The shower has a variety of water outflow functions; or a shower and a spray lance are combined to fulfill the functions of the shower and the spray lance.

In the related art, a Chinese utility model patent CN216704726U provides a shower having a spray lance function. The shower has spray lance water outflow and shower water outflow functions, and has a variety of water outflow functions. The water outflow functions of the shower are switched by rotating a surface cover to drive a water distributor, and the flow of the shower is adjusted by a water outflow switch located away from the shower. The water outflow switch is generally disposed at a water outflow pipe on a wall or on a shower or a bathtub. A water outlet of the water outflow switch is connected to the shower through a hose, such that the shower is inconvenient in flow adjustment, and has limited functions and poor user experience.

### SUMMARY

The present application aims to solve one of the technical problems in the above-mentioned technology at least to some extent. To this end, an objective of the present application is to provide a multifunctional shower, which has a shower water outflow function, a flow adjustment function and a spray lance function and improves user experience.

In order to achieve the above objective, an embodiment of the present application provides a multifunctional shower which includes a shower body, a diverter valve, a flow adjustment mechanism and a water outflow panel.

A water inflow channel is formed in the shower body, and a spray nozzle is disposed on the shower body.

The water outflow panel is mounted on the shower body.

The diverter valve includes a water inflow cavity, a spray lance water outflow cavity, a shower water outflow cavity, and a mounting cavity. A water inflow end of the water inflow cavity communicates with the water inflow channel, and a water outflow end of the water inflow cavity communicates with the spray lance water outflow cavity or the mounting cavity. A water outflow end of the spray lance water outflow cavity communicates with the spray nozzle. A water outflow end of the shower water outflow cavity communicates with the water outflow panel. The mounting cavity is provided with a water outlet communicating with the shower water outflow cavity.

The flow adjustment mechanism includes a movable ceramic disc, a toggle bar and a push button. The movable ceramic disc is mounted in the mounting cavity and is rotatable relative to the mounting cavity. The toggle bar is connected to the movable ceramic disc and the push button, and the push button is disposed on an outside of the shower body. When the push button is pushed, the toggle bar drives the movable ceramic disc to rotate so as to adjust an overlapping area of an adjustment hole of the movable ceramic disc and the water outlet of the mounting cavity, thereby adjusting the water flow of the shower water outflow cavity.

According to the multifunctional shower of the embodiment of the present application, the shower water outflow and spray lance water outflow functions are achieved by disposing the diverter valve. The flowing area of water is changed by changing the overlapping area of the adjustment hole of the movable ceramic disc and the mounting hole of the mounting cavity via the flow adjustment mechanism that is mounted in the mounting cavity of the diverter valve, thereby adjusting the water flow of the shower. The flow is adjusted by pushing the push button, such that the shower has the shower water outflow function, the flow adjustment function and the spray lance function, and improves the user experience.

Optionally, the spray lance water outflow cavity is provided with a first water channel and a second water channel independent from each other, and the spray nozzle is provided with a first-aperture spray hole and second-aperture spray holes. The first water channel communicates with the first-aperture spray hole, and the second water channel communicates with the second-aperture spray holes. Therefore, the shower has a dual-spray lance function, for example, the first-aperture spray hole sprays the first type spray lance water, and the second-aperture spray holes spray the second type of spray lance water.

Further, there are a plurality of second-aperture spray holes, and the second-aperture spray holes are spaced apart in the spray nozzle.

Further, the multifunctional shower includes a first switching valve and a second switching valve. Valve sleeves of the first switching valve and the second switching valve are disposed at intervals on the water inflow cavity, and movable valve shafts are disposed in the valve sleeves. The valve shafts are connected to buttons, and the buttons are disposed on the outside of the shower body. The valve shafts move up and down when the buttons are pressed, such that the first switching valve performs switching to make the water outflow end of the water inflow cavity communicate with the first water channel, or the second switching valve performs switching to make the water outflow end of the water inflow cavity communicate with the second water channel. Therefore, switching between a spray lance water channel and a shower water channel can be achieved by pressing the button of the first switching valve or the second switching valve.

More specifically, the buttons are disposed on a back surface of the shower body. The first switching valve and the second switching valve are provided with springs, respectively, and the springs elastically connect the valve shafts and the valve sleeves such that the valve shafts are movable within the valve sleeves.

Optionally, a first through hole is formed in a side wall of the shower body. The toggle bar is provided with a slider bar abutting against an inner side wall of the shower body. A connecting portion of the push button is inserted from the first through hole and connected to the slider bar, and the slider bar slides on the inner side wall of the shower body when the push button is pushed to slide on an outer side wall of the shower body so as to deflect the toggle bar, thereby driving the movable ceramic disc to rotate. Therefore, the shower water flow can be adjusted by pushing the push button on a side surface of the shower body.

Optionally, an axially penetrating mounting hole is disposed in the center of the movable ceramic disc. A mounting shaft is disposed in the mounting cavity. The mounting hole is in sleeve joint with the mounting shaft.

Optionally, a cross section of the adjustment hole and a cross section of the water outlet of the mounting cavity are both in an arc shape.

Optionally, the diverter valve is provided with a main body, a first sealing plate and a second sealing plate. The first sealing plate is disposed on a top surface of the main body to seal the shower water outflow cavity and the spray lance water outflow cavity, and the second sealing plate is disposed on a bottom surface of the main body to seal the water inflow cavity and the mounting cavity. The second sealing plate is provided with a pole adapted to be inserted into the mounting cavity to construct the mounting shaft. A side wall of the main body is provided with a second through hole, and the toggle bar is inserted into the second through hole and is connected to the movable ceramic disc.

Further, a communication cavity is formed on the bottom surface of the main body. A water inflow end of the communication cavity communicates with the water outflow end of the shower water outflow cavity, and a water outflow end of the communication cavity communicates with the water outflow panel.

Optionally, the multifunctional shower further includes a sealing cover and a water distributor. The water outflow panel includes a water outflow body, a massage water rotor and a decorative cover. The sealing cover is disposed at a bottom of the diverter valve and communicates with the shower water outflow cavity. The water distributor is disposed at a bottom of the sealing cover and is provided with a plurality of independent water distributing cavities. The water outflow body is disposed at a bottom of the water distributor and is provided with a plurality of water outlets for sprinkling water from the shower. The massage water rotor is in rotational sleeve joint with the water outflow body and is located between the water distributor and the water outflow body. The decorative cover is disposed on an outer side of the water outflow body, and is provided with through holes in sleeve joint with the plurality of the water outlets in a one-to-one correspondence manner, and the decorative cover can drive the water outflow body to rotate relative to the water distributor such that each of the water outlets communicates with one or all of the water distributing cavities. Therefore, the shower water outflow cavity can achieve a variety of water outflow functions.

The additional aspects and advantages of embodiments of the present application will be set forth in part in the description below, and will be obvious in part from the description below, or may be learned by the practicing of the embodiments of the present application.

### BRIEF DESCRIPTION OF FIGURES

FIG. 1 is a stereoscopic view from a first perspective of a shower according to an embodiment of the present application;

FIG. 2 is a stereoscopic view from a second perspective of a shower according to an embodiment of the present application;

FIG. 3 is a stereoscopic view from a third perspective of a shower according to an embodiment of the present application;

FIG. 4 is an exploded view of a shower according to an embodiment of the present application;

FIG. 5 is a section view from a first perspective of a shower according to an embodiment of the present application;

FIG. 6 is a section view from a second perspective of a shower according to an embodiment of the present application;

FIG. 7 is a section view from a third perspective of a shower according to an embodiment of the present application;

FIG. 8 is a schematic diagram of part of components of a shower according to an embodiment of the present application;

FIG. 9 is a section view from a fourth perspective of a shower according to an embodiment of the present application;

FIG. 10 is a schematic diagram from a first perspective of spray lance water channel according to an embodiment of the present application;

FIG. 11 is a schematic diagram from a second perspective of a spray lance water channel according to an embodiment of the present application;

FIG. 12 is an assembly diagram of a diverter valve and a flow adjustment mechanism according to an embodiment of the present application;

FIG. 13 is an assembly diagram from another perspective of a diverter valve according to an embodiment of the present application;

FIG. 14 is a schematic diagram of a flow adjustment mechanism according to an embodiment of the present application;

FIG. 15 is an exploded view of a flow adjustment mechanism according to an embodiment of the present application;

FIG. 16 is a section view from a fifth perspective of a shower according to an embodiment of the present application;

FIG. 17 is a diagram illustrating the states of changes in an overlapping area of an adjustment hole and a water outlet during an adjustment process according to an embodiment of the present application;

FIG. 18 is an assembly diagram of part of components of a shower according to an embodiment of the present application.

### DESCRIPTION OF REFERENCE NUMERALS

shower body 1, water inflow channel 101, accommodation cavity 102, first through hole 103, spray nozzle 110, first-aperture spray hole 111, second-aperture spray hole 112;

diverter valve 2, water inflow cavity 201, spray lance water outflow cavity 202, first water channel 2021, second water channel 2022, shower water outflow cavity 203, mounting cavity 204, water outlet 2041, communication cavity 205, main body 210, second through hole 211, first sealing plate 220, second sealing plate 230, pole 231, conical pad 240;

flow adjustment mechanism 3, movable ceramic disc 310, adjustment hole 311, mounting hole 312, toggle bar 320, slider bar 321, push button 330;

water outflow panel 4, water outflow body 410, a massage water rotor 420, decorative cover 430, handle 431;

first switching valve 510, valve sleeve 511, valve shaft 512, button 513, spring 514, second switching valve 520;

sealing cover 6;

water distributor 7, water distributing cavity 701.

### DETAILED DESCRIPTION

Embodiments of the present application will be described in detail below, and examples of the embodiments are illustrated in the accompanying drawings, wherein the same or similar reference numerals refer to the same or similar elements or elements having the same or similar function throughout. The embodiments described below by referring to the accompanying drawings are exemplary, are intended to explain the present application and are not to be understood as limiting the present application.

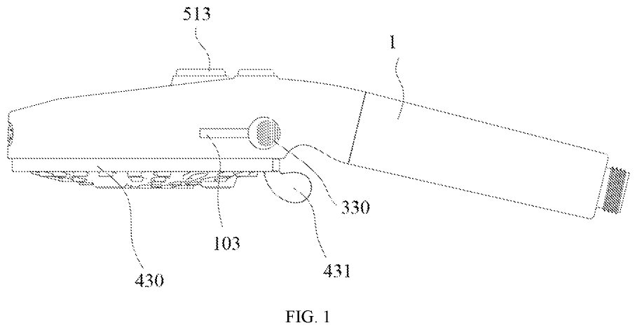

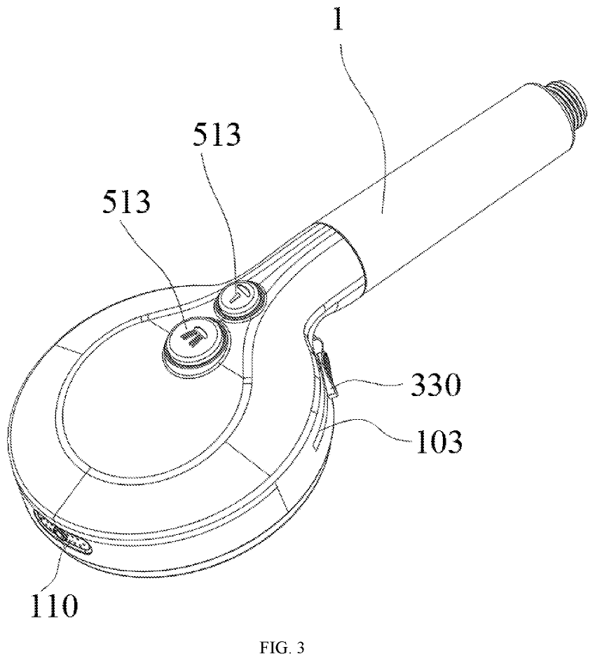

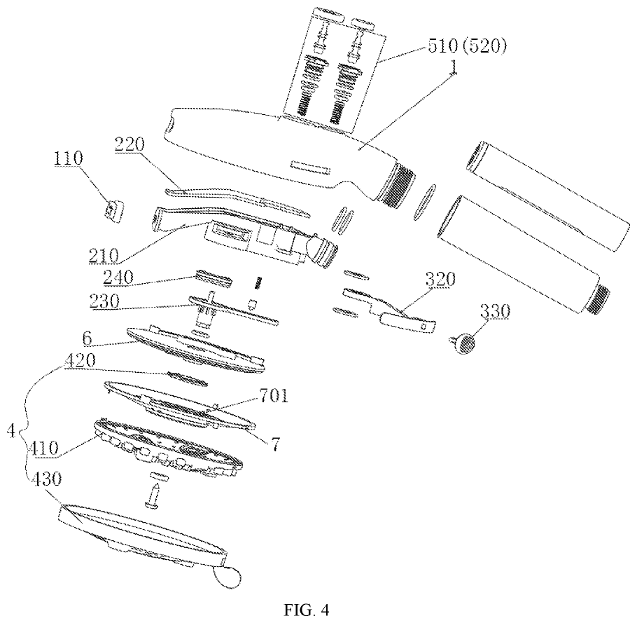

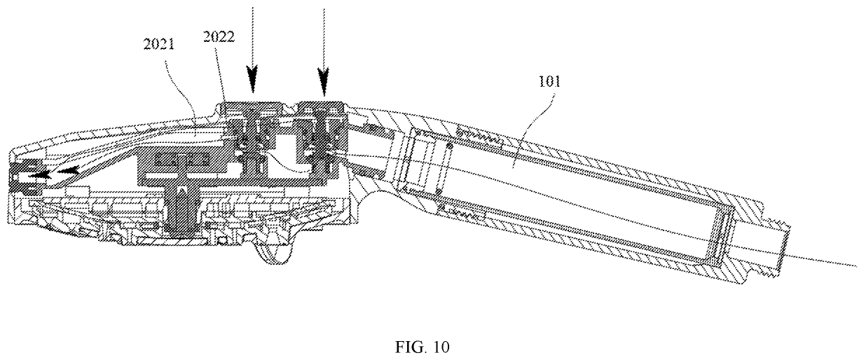

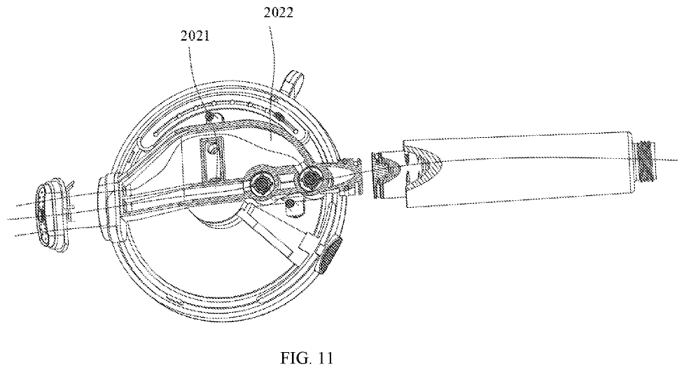

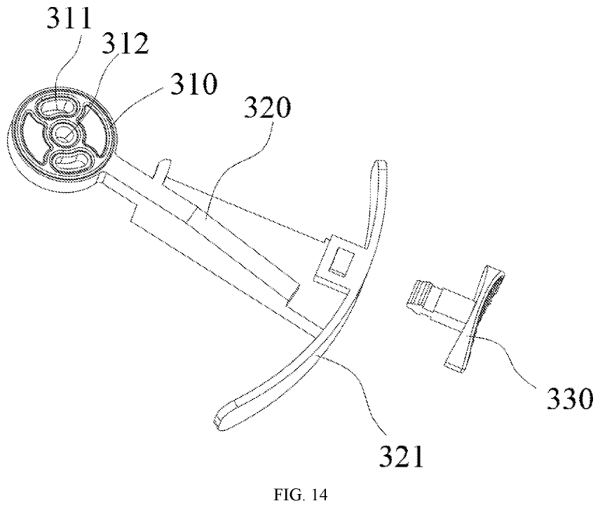

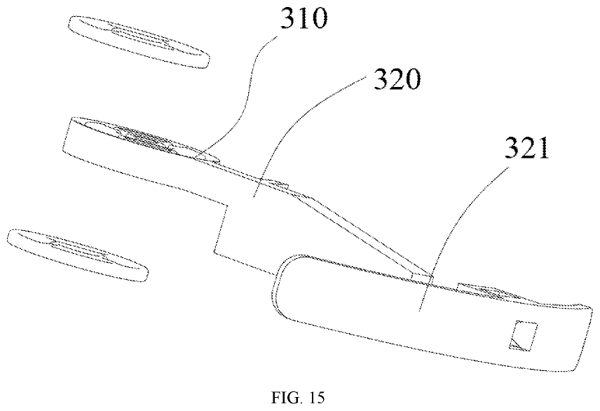

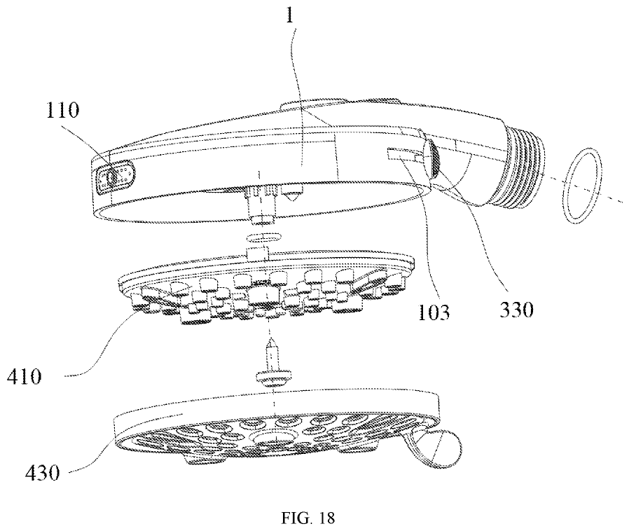

A multifunctional shower according to the embodiments of the present application will now be described in detail with reference to FIGS. 1-18.

As shown in FIGS. 1-4, a multifunctional shower according to an embodiment of the present application includes a shower body 1, a diverter valve 2, a flow adjustment mechanism 3 and a water outflow panel 4.

Specifically, a water inflow channel 101 is formed in the shower body 1, and a spray nozzle 110 is disposed on the shower body 1. The water outflow panel 4 is mounted on the shower body 1. The diverter valve 2 includes a water inflow cavity 201, a spray lance water outflow cavity 202, a shower water outflow cavity 203 and a mounting cavity 204. A water inflow end of the water inflow cavity 201 communicates with the water inflow channel 101, and a water outflow end of the water inflow cavity 201 communicates with the spray lance water outflow cavity 202 or the mounting cavity 204. A water outflow end of the spray lance water outflow cavity 202 communicates with the spray nozzle 110, and a water outflow end of the shower water outflow cavity 203 communicates with the water outflow panel 4. The mounting cavity 204 is provided with a water outlet 2041 communicating with the shower water outflow cavity 203. The flow adjustment mechanism 3 includes a movable ceramic disc 310, a toggle bar 320 and a push button 330. The movable ceramic disc 310 is mounted in the mounting cavity 204 and is rotatable relative to the mounting cavity 204, and the toggle bar 320 connects the movable ceramic disc 310 and the push button 330 that is disposed on an outside of the shower body 1. When the push button 330 is pushed, the toggle bar 320 drives the movable ceramic disc 310 to rotate so as to adjust an overlapping area of an adjustment hole 311 of the movable ceramic disc 310 and the water outlet 2041 of the mounting cavity 204, thereby adjusting the water flow of the shower water outflow cavity 203.

In other words, the shower has the following innovation points: The movable ceramic disc 310 of the flow adjustment mechanism 3 is mounted in the mounting cavity 204 of the diverter valve 2, and the water outflow amount of the shower water outflow cavity 203 is implemented by the adjustment of the overlapping area of the adjustment hole 311 of the movable ceramic disc 310 and the water outlet 2041 of the mounting cavity 204 to further adjust the shower water flow, so that the shower can be used not only to realize various shower water outflow functions and spray lance functions, but also has an additional flow adjustment function.

It may be understood that the water outflow panel 4 is mounted on the shower body 1 and defines an accommodation cavity 102 together with the shower body 1, and the diverter valve 2 is integrally arranged in the accommodation cavity 102. Switching that the water outflow end of the water inflow cavity 201 of the diverter valve 2 communicates with the spray lance water outflow cavity 202, the shower water outflow cavity 203 or the mounting cavity 204 can be implemented by providing switching valves. The spray lance water outflow function of the shower can be realized when the water outflow end of the water inflow cavity 201 of the diverter valve 2 communicates with the spray lance water outflow cavity 202, and the shower water outflow function of the shower can be realized when the water outflow end of the water inflow cavity 201 of the diverter valve 2 communicates with the mounting cavity 204 which in turn communicates with the shower water outflow cavity 203.

Therefore, according to the multifunctional shower of the embodiment of the present application, the shower water outflow and spray lance water outflow functions are achieved by disposing the diverter valve 2. The flowing area of water (water in the mounting cavity 204 flows to the shower water outflow cavity 203) is changed by changing the overlapping area of the adjustment hole 311 of the movable ceramic disc 310 and the water outlet 2041 of the mounting cavity 204 via the flow adjustment mechanism 3 that is mounted in the mounting cavity 204 of the diverter valve 2, thereby adjusting the shower water flow. The flow is adjusted by pushing the push button 330, such that the shower has the shower water outflow function, the flow adjustment function and the spray lance function, and improves the user experience.

The above embodiment is the most basic solution of the present application, has been able to solve the problems set forth in the background and achieves the objective of the present application. Hereinafter, the above basic solution can be modified in various ways to further improve its performance, thereby achieving a better implementation effect.

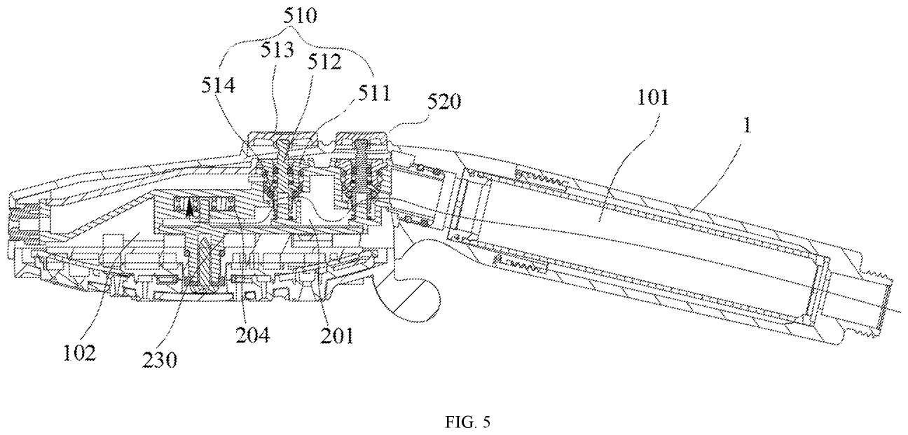

With reference to FIGS. 5, 6 and 8, the spray lance water outflow cavity 202 is provided with a first water channel 2021 and a second water channel 2022 independent from each other, and the spray nozzle 110 is provided with a first-aperture spray hole 111 and second-aperture spray holes 112. The first water channel 2021 communicates with the first-aperture spray hole 111, and the second water channel 2022 communicates with the second-aperture spray holes 112. That is, according to the embodiment, two independent water channels are arranged for the spray lance water outflow function, and two spray lance water outflow modes can be realized by designing different aperture sizes of the spray holes in the spray nozzle 110. In this way, the shower may have a dual-spray lance function, the first-aperture spray hole 111 sprays the first type of spray lance water, and the second-aperture spray holes 112 spray the second type of spray lance water. For example, the first-aperture spray hole 111 sprays the spray lance water with a greater impact force or coalesced spray lance water, and the second-aperture spray holes 112 spray the spray lance water with a smaller impact force or fan-shaped spray lance water.

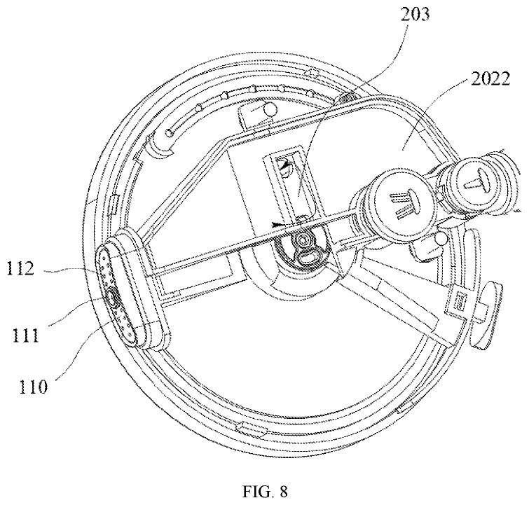

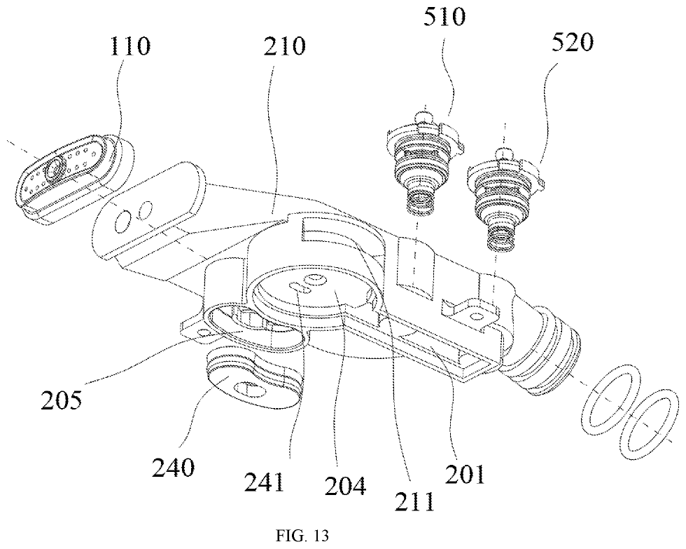

More specifically, there are a plurality of second-aperture spray holes 112 that are spaced apart in the spray nozzle 110. In this way, the second-aperture spray holes 112 spray the second type of spray lance water. As shown in FIG. 8, the first-aperture spray hole 111 is formed in the middle position of the spray nozzle 110 to spray the first type of spray lance water, and the plurality of second-aperture spray holes 112 are formed in the peripheral position of the first first-aperture spray hole 111 to spray the second type of spray lance water. Referring to FIG. 13, the spray nozzle 110 may be provided with a first water outflow channel and a second water outflow channel which correspondingly communicate with a water outflow end of the first water channel 2021 and a water outflow end of the second water channel 2022 one by one. The first water outflow channel is disposed in the second water outflow channel, and the first water outflow channel and the second water outflow channel are independent from each other. A water outflow end of the first water outflow channel is the first-aperture spray hole 111, and the plurality of second orifice spray holes 112 are disposed in a water outflow end of the second water outflow channel.

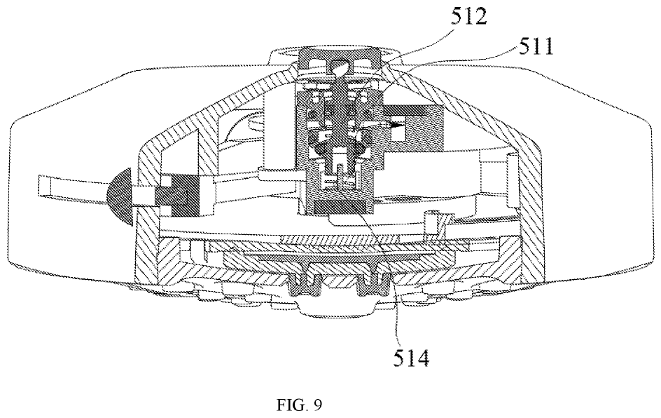

With reference to FIGS. 9-11, switching that the first water channel 2021 or the second water channel 2022 of the spray lance water outflow cavity 202, or the mounting cavity 204 communicates with the water inflow cavity 201 may be performed by disposing a first switching valve 510 and a second switching valve 520 on the water inflow cavity 201, wherein the first switching valve 510 and the second switching valve 520 have the same structure and principle, and by taking the first switching valve 510 as an example for detailed description, the first switching valve 510 includes a valve sleeve 511, a valve shaft 512 and a button 513. The valve sleeves 511 of the first switching valve 510 and the second switching valve 520 are disposed on the water inflow cavity 201 at intervals, and the movable valve shafts 512 are disposed in the valve sleeves 511, and are connected to the buttons 513 that are disposed on the outside of the shower body 1. The valve shafts 512 move up and down when the buttons 513 are pressed, such that the first switching valve 510 performs switching to make the water outflow end of the water inflow cavity 201 communicate with the first water channel 2021, or the second switching valve 520 performs switching to make the water outflow end of the water inflow cavity 201 communicate with the second water channel 2022. Therefore, switching between a spray lance water channel and a shower water channel can be achieved by pressing the button of the first switching valve 510 or the second switching valve 520.

The first switching valve 510 is behind the second switching valve 520 with respect to a water inflow direction of the water inflow channel 101.

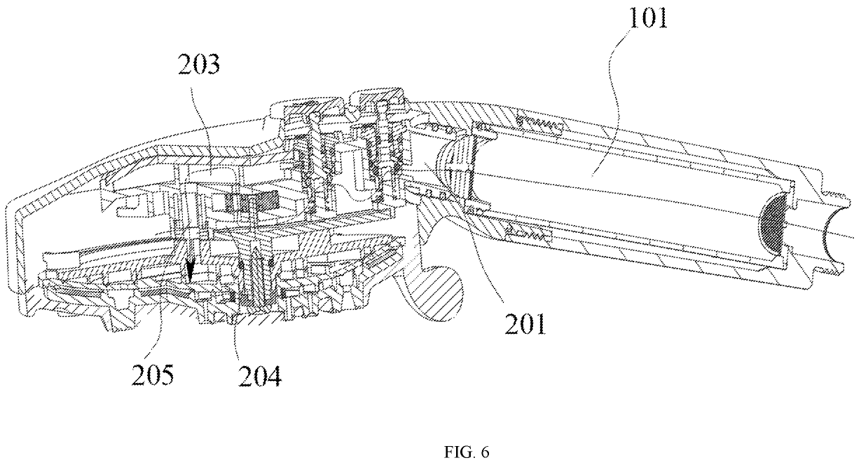

More specifically, as shown in FIGS. 5 and 6, the first switching valve 510 and the second switching valve 520 are provided with springs 514, respectively, which elastically connect the valve shafts 512 and the valve sleeves 511 such that the valve shafts 512 are movable in the valve sleeves 511. A side wall of each valve sleeve 511 is provided with a water outflow end communicating with the first water channel 2021 or the second water channel 2022, and a sealing ring is disposed between each valve sleeve 511 and each valve shaft 512 to perform a sealing function between the valve shaft 512 and the valve sleeve 511.

For switching of water types, when the buttons 513 of the first switching valve 510 and the second switching valve 520 are in a natural state, the elastic force of the springs 514 is applied to the valve shafts 512 so as to control the valve shafts 512 to move upwards to seal the water outflow ends of the valve sleeves 511 corresponding to the spray lance water outflow cavity 202. In this case, the mounting cavity 204 communicates with the water inflow channel 101 (as shown in FIG. 5). When flowing to the shower, water flows through the water inflow channel 101 into the mounting cavity 204, further into the shower water outflow cavity 203, and then flows through the shower water outflow cavity 203 into the water outflow panel 4 to supply shower water.

When the button 513 of the first switching valve 510 is pressed and the button 513 of the second switching valve 520 is in a natural state, the valve shaft 512 moves downwards by pressing the button 513, and water may produce a back pressure at the valve shaft 512. At the moment, the back pressure is greater than the elastic force of the spring 514, and the valve shaft 512 may seal the water flowing position of the water inflow cavity 201 communicating with the mounting cavity 204, so that the first water channel 2021 communicates with the water inflow cavity 201 at the moment. When water is introduced, water flows into the first water channel 2021 through the water inflow channel 101, and then the first type of spray lance water is sprayed through the first-aperture spray hole 111, which has a high impact force, and can be used for washing floors, cleaning dirt, and the like.

When the button 513 of the second switching valve 520 is pressed and the button 513 of the first switching valve 510 is in a natural state, the valve shaft 512 moves downwards by pressing the button 513, and water may produce a back pressure at the valve shaft 512. At the moment, the back pressure is greater than the elastic force of the spring 514, and the valve shaft 512 prevents water from entering the next channel, so that the second water channel 2022 communicates with the water inflow cavity 201 at the moment. When water is introduced, water flows into the second water channel 2022 through the water inflow channel 101, and then the second type of spray lance water is sprayed through the second-aperture spray holes 112, which has a high impact force, and can be used for washing floors, cleaning dirt, and the like.

Continuous pressing is required when the button 513 is pressed, and the spray lance water outflow mode shuts down when the button is released, so that the water channel is switched for the shower water outflow mode.

In addition, the buttons 513 of the first switching valve 510 and the second switching valve 520 may be disposed on the back surface of the shower body 1 to facilitate the operation of the buttons 513 by a user when the user holds a hand shank of the shower.

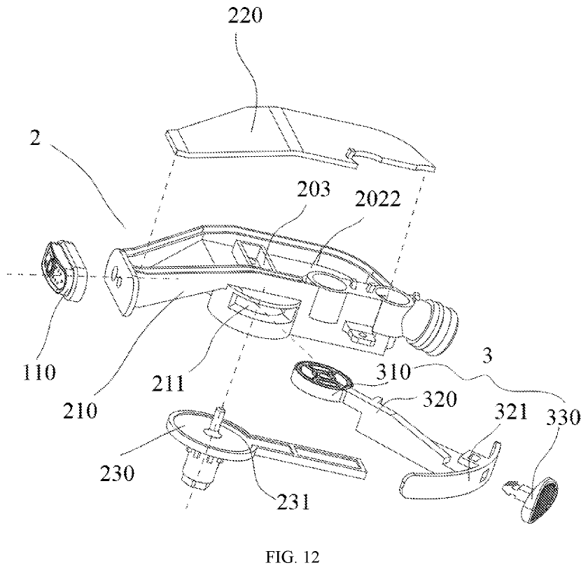

With reference to FIGS. 12-15, a first through hole 103 is formed in a side wall of the shower body 1. The toggle bar 320 is provided with a slider bar 321 abutting against an inner side wall of the shower body 1. A connecting portion of the push button 330 is inserted from the first through hole 103 and connected to the slider bar 321, and the slider bar 321 slides on the inner side wall of the shower body 1 when the push button 330 is pushed to slide on an outer side wall of the shower body 1 so as to deflect the toggle bar 320, thereby driving the movable ceramic disc 310 to rotate. Therefore, the shower water flow can be adjusted by pushing the push button 330 on the side surface of the shower body 1. The connecting portion of the push button 330 and the slider bar 321 may be in fastener connection.

That is, when the push button 330 is operated on the outer side wall of the shower body 1 to move along the circumferential contour of the outer side wall of the shower body 1, the connecting portion of the push button 330 moves inside the first through hole 103, such that the slider bar 321 slides on the circumferential contour of the inner side wall of the shower body 1 so as to deflect the slider bar 320, and thus the adjustment hole 311 of the movable ceramic disc 310 and the water outlet 2041 of the mounting cavity 204 are brought into overlap to lead to communication, or brought into misalignment to lead to no communication in an up-down direction, thereby adjusting the overlapping area to adjust the flow of water entering the shower water outflow cavity 203.

The push button 330 is disposed on the side surface of the shower body 1, and the flow adjustment mechanism 3 formed by the cooperation of the push button 330, the toggle bar 320 and the movable ceramic disc 310 facilitates the one-handed operation of the user to adjust the water outflow amount of the shower.

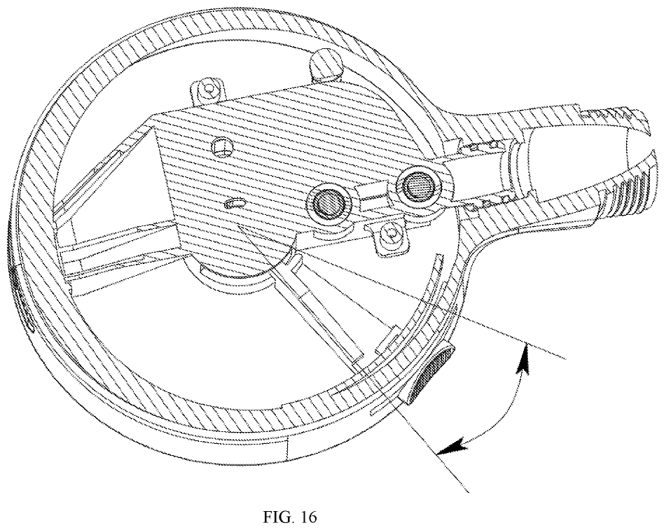

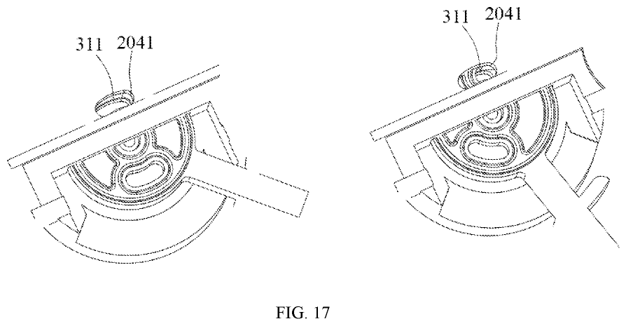

Further, with reference to FIGS. 16 and 17, the cross section of the adjustment hole 311 and the cross section of the water outlet 2041 of the mounting cavity 204 are both in an arc shape, thereby facilitating the adjustment of the overlapping area of the adjustment hole 311 and the water outlet 2041. The water outlet 2041 is located above the adjustment hole 311. When the push button 330 is at the initial position, the adjustment hole 311 completely overlaps with the water outlet 2041, the positions of the adjustment hole and the water outlet are aligned. When the push button 330 is moved to rotate the toggle bar 320 by a certain angle, the adjustment hole 311 and the water outlet 2041 are misaligned to communicate with each other, so that the area of the water channel is changed, thereby achieving the flow adjusting function.

In addition, an axially penetrating mounting hole 312 is disposed in the center of the movable ceramic disc 310. A mounting shaft is disposed in the mounting cavity 204. The mounting hole 312 is in sleeve joint with the mounting shaft. Therefore, the movable ceramic disc 310 is rotationally assembled in the mounting cavity 204.

With reference to FIGS. 12 and 13, for the diverter valve 2, the diverter valve 2 is provided with a main body 210, a first sealing plate 220 and a second sealing plate 230. The first sealing plate 220 is disposed on a top surface of the main body 210 to seal the shower water outflow cavity 203 and the spray lance water outflow cavity 202, and the second sealing plate 230 is disposed on a bottom surface of the main body 210 to seal the water inflow cavity 201 and the mounting cavity 204. The second sealing plate 230 is provided with a pole 231 adapted to be inserted into the mounting cavity 204 to construct the mounting shaft. A side wall of the main body 210 is provided with a second through hole 211, and the toggle bar 320 is inserted into the second through hole 211 and is connected to the movable ceramic disc 310.

The first sealing plate 220 and the second sealing plate 230 may be connected to the main body 210 by welding.

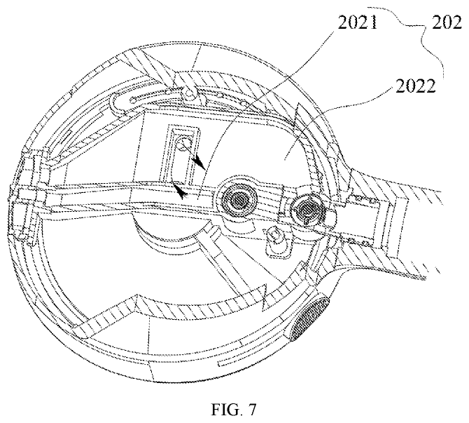

More specifically, with reference to FIG. 7, in the diverter valve 2, the shower water outflow cavity 203 and the spray lance water outflow cavity 202 are disposed on the top surface of the main body 210 and are independent from each other, and the first water channel 2021 and the second water channel 2022 of the spray lance water outflow cavity 202 are also independent from each other. The water inflow cavity 201 and the mounting cavity 204 are disposed on the bottom surface of the main body 210 and communicate with each other. The main body 210 is provided with two spaced-apart through holes penetrating through the top surface of the main body 210 at a position where the water inflow cavity 201 is close to the water inflow end, and the two through holes are respectively used for the installation of the valve sleeves 511 of the first switching valve 510 and the second switching valve 520.

Further, a communication cavity 205 is formed on the bottom surface of the main body 210. A water inflow end of the communication cavity 205 communicates with the water outflow end of the shower water outflow cavity 203, and a water outflow end of the communication cavity 205 communicates with the water outflow panel 4. That is, water from the shower water outflow cavity 203 flows into the communication cavity 205 and then into the water outflow panel 4. The communication cavity 205 is provided to introduce water from the shower water outflow cavity 203 located on the top surface of the main body 210 into the water outflow panel 4 which is located underneath the main body 210. The communication cavity 205 and the mounting cavity 204 are independent from each other.

More specifically, the communication cavity 205 is plugged with a conical pad 240 that is provided with a water outlet, so that the communication cavity 205 can communicate with the water outflow panel 4.

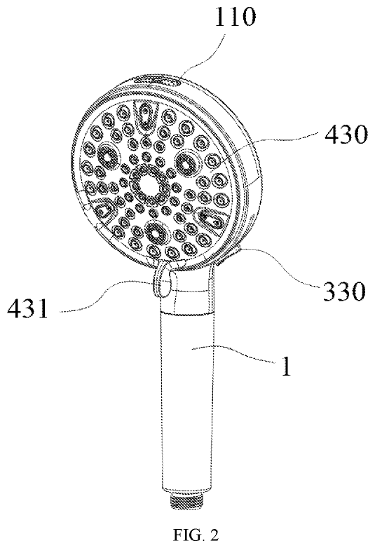

With reference to FIGS. 2, 4 and 18, in order to achieve various shower water outflow functions, the shower further includes a sealing cover 6 and a water distributor 7. The water outflow panel 4 includes a water outflow body 410, a massage water rotor 420 and a decorative cover 430. The sealing cover 6 is disposed at a bottom of the diverter valve 3, communicates with the shower water outflow cavity 203, and more specifically, communicates with the water outflow end of the communication cavity 205. The water distributor 7 is disposed at a bottom of the sealing cover 6 and is provided with a plurality of independent water distributing cavities 701. The water outflow body 410 is disposed at a bottom of the water distributor 7 and is provided with a plurality of water outlets 411 for sprinkling water from the shower. The massage water rotor 420 is in rotational sleeve joint with the water outflow body 410 and is located between the water distributor 7 and the water outflow body 410. The decorative cover 430 is disposed on an outer side of the water outflow body 410, and is provided with through holes that are in sleeve joint with the plurality of the water outlets 411 in a one-to-one correspondence manner, and the decorative cover 430 can drive the water outflow body 410 to rotate relative to the water distributor 7 such that each of the water outlets 411 communicates with one or all of the water distributing cavities 701. Therefore, the shower water outflow cavity 203 can achieve a variety of water outflow functions.

The water distributor 7 cooperates with the water outflow body 410 and the massage water rotor 420 to be capable of achieving various water outflow functions by adopting the existing structure. The water outflow body 410 is driven to rotate by rotating the decorative cover 430, such that the decorative cover 430 can achieve a variety of water outflow manners.

More specifically, the decorative cover 430 is provided with a handle 431 so that a user toggles the handle 431 to rotate the decorative cover 430.

The assembly process of the shower may be performed as follows: Firstly, the first sealing plate 220 is welded on the main body 210, the first switching valve 510 and the second switching valve 520 are assembled on the main body 210, and then the spray nozzle 110 is welded on the main body 210. Then, according to the manner as shown in FIG. 13, the sealing ring is assembled on the movable ceramic disc 310 that is then inserted into the mounting cavity 204 from the second through hole 2042, the pole 231 of the second sealing plate 230 is inserted into the mounting hole 312 of the movable ceramic disc 310, and then, the second sealing plate 230 is welded on the main body 210. Subsequently, the assembled diverter valve 2 and flow adjustment mechanism 3 are mounted inside the accommodation cavity 102 of the shower body 1, the push button 330 is inserted from the first through hole 103 and clamped to the slider bar 321, and then a screw is used for locking from the second sealing plate 230 to fix the diverter valve 2 to the shower body 1. Afterwards, the sealing cover 6, the water distributor 7, the massage water rotor 420 and the water outflow body 410 are fixed to the diverter valve 2 by screws, and then the decorative cover 430 is buckled to the water outflow body 410. Finally, a filter element is mounted on the hand shank that is screwed to a shower head, and the two buttons 513 are mounted.

In the description of the application, it should be understood that, the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, or the like indicate an orientation or positional relationship based on the orientation or positional relationship as shown in the accompanying drawings, and are only for facilitating the description of the present application and for simplifying the description, rather than indicating or implying that the device or element referred to needs to have a particular orientation, be constructed and operate in a particular orientation, and therefore should not be construed as limiting the present application.

Furthermore, the terms “first” and “second” are used for descriptive purposes only, and cannot be understood to indicate or imply relative importance or to implicitly specify the number of technical features indicated. Therefore, the features defined by “first” and “second” may explicitly or implicitly include one or more of the features. In the description of the present application, “a plurality of” means two or more, unless expressly and specifically defined otherwise.

In the present application, unless expressly specified and defined otherwise, the terms “mount”, “link”, “connect”, “fix” or the like should be broadly understood. For example, it may be fixed connection, detachable connection or integrated connection, may be mechanical connection or electrical connection, may be direct connection or indirect connection through intermediate media, may be internal connection of two elements, or indicates an interacting relationship between two elements. Those of ordinary in the art may understand the specific meanings of the above terms in the present application according to specific conditions.

In the present application, unless expressly specified and defined otherwise, a first feature being “above” or “below” a second feature may include that the first and second features are in direct contact or that the first and second features are not in direct contact but are in contact through another feature therebetween. Moreover, a first feature being “above” “on” or “over” a second feature includes that the first feature is directly above and obliquely above the second feature, or simply indicates that the first feature is at a higher level than the second feature. A first feature being “below”, “under” or “beneath” a second feature includes that the first feature is directly below and obliquely below the second feature, or simply indicates that the first feature is at a lower level than the second feature.

In the description of the present application, descriptions with reference to the terms “one embodiment”, “some embodiments”, “an example”, “a specific example”, or the like indicate that the specific features, structures, materials, or characteristics described in combination with the embodiments or examples are included in at least one embodiment or example of the present application. In this specification, the illustrative descriptions of the above terms do not necessarily refer to the same embodiment or example. Furthermore, the specific features, structures, materials, or characteristics described may be combined in a suitable manner in any one of or a plurality of embodiments or examples. In addition, different embodiments or examples described in this specification may be joined and combined by those skilled in the art.

Although the embodiments of the present application have been shown and described above, it will be appreciated that the above embodiments are illustrative and not to be construed as limiting the present application, and those of ordinary skill in the art may make changes, modifications, substitutions, and variations to the above embodiments within the scope of the present application.

What is claimed is:

1. A multifunctional shower, comprising a shower body, a diverter valve, a flow adjustment mechanism and a water outflow panel, wherein
a water inflow channel is formed in the shower body and a spray nozzle is disposed on the shower body;
the water outflow panel is mounted on the shower body;
the diverter valve comprises a water inflow cavity, a spray lance water outflow cavity, a shower water outflow cavity, and a mounting cavity, wherein a water inflow end of the water inflow cavity communicates with the water inflow channel, and a water outflow end of the water inflow cavity communicates with the spray lance water outflow cavity or the mounting cavity; a water outflow end of the spray lance water outflow cavity communicates with the spray nozzle, and a water outflow end of the shower water outflow cavity communicates with the water outflow panel; the mounting cavity is provided with a water outlet communicating with the shower water outflow cavity;
the flow adjustment mechanism comprises a movable ceramic disc, a toggle bar and a push button, wherein the movable ceramic disc is mounted in the mounting cavity and is rotatable relative to the mounting cavity, the toggle bar is connected to the movable ceramic disc and the push button, and the push button is disposed on an outside of the shower body; and when the push button is pushed, the toggle bar drives the movable ceramic disc to rotate so as to adjust an overlapping area of an adjustment hole of the movable ceramic disc and the water outlet of the mounting cavity, thereby adjusting the water flow of the shower water outflow cavity.

2. The multifunctional shower of claim 1, wherein the spray lance water outflow cavity is provided with a first water channel and a second water channel which are independent from each other; the spray nozzle is provided with a first-aperture spray hole and second-aperture spray holes; and the first water channel communicates with the first-aperture spray hole, and the second water channel communicates with the second-aperture spray holes.

3. The multifunctional shower of claim 2, wherein a plurality of second-aperture spray holes are provided and are spaced apart in the spray nozzle.

4. The multifunctional shower of claim 2, further comprising a first switching valve and a second switching valve, wherein valve sleeves of the first switching valve and the second switching valve are disposed at intervals on the water inflow cavity; movable valve shafts are disposed in the valve sleeves, and the valve shafts are connected to buttons that are disposed on the outside of the shower body; and the valve shafts move up and down when the buttons are pressed such that the first switching valve performs switching to make the water outflow end of the water inflow cavity communicate with the first water channel, or the second switching valve performs switching to make the water outflow end of the water inflow cavity communicate with the second water channel.

5. The multifunctional shower of claim 4, wherein the buttons are disposed on a back surface of the shower body, the first switching valve and the second switching valve are provided with springs, respectively, and the springs connect the valve shafts and the valve sleeves such that the valve shafts are movable within the valve sleeves.

6. The multifunctional shower of claim 1, wherein a first through hole is formed in a side wall of the shower body; the toggle bar is provided with a slider bar abutting against an inner side wall of the shower body; a connecting portion of the push button is inserted from the first through hole and connected to the slider bar; and the slider bar slides on the inner side wall of the shower body when the push button is pushed to slide on an outer side wall of the shower body so as to deflect the toggle bar, thereby driving the movable ceramic disc to rotate.

7. The multifunctional shower of claim 1, wherein an axially penetrating mounting hole is disposed in the center of the movable ceramic disc, a mounting shaft is disposed in the mounting cavity, and the mounting hole is in sleeve joint with the mounting shaft.

8. The multifunctional shower of claim 7, wherein a cross section of the adjustment hole and a cross section of the water outlet of the mounting cavity are both in an arc shape.

9. The multifunctional shower of claim 7, wherein the diverter valve is provided with a main body, a first sealing plate and a second sealing plate; the first sealing plate is disposed on a top surface of the main body to seal the shower water outflow cavity and the spray lance water outflow cavity; the second sealing plate is disposed at a bottom surface of the main body to seal the water inflow cavity and the mounting cavity; and the second sealing plate is provided with a pole adapted to be inserted into the mounting cavity to construct the mounting shaft; a side wall of the main body is provided with a second through hole, and the toggle bar is inserted into the second through hole and connected to the movable ceramic disc.

10. The multifunctional shower of claim 9, wherein a communication cavity is formed on the bottom surface of the main body, a water inflow end of the communication cavity communicates with the water outflow end of the shower water outflow cavity, and a water outflow end of the communication cavity communicates with the water outflow panel.

11. The multifunctional shower of claim 1, further comprising a sealing cover and a water distributor, wherein the water outflow panel comprises a water outflow body, a massage water rotor and a decorative cover; the sealing cover is disposed at a bottom of the diverter valve and communicates with the shower water outflow cavity; the water distributor is disposed at a bottom of the sealing cover and is provided with a plurality of independent water distributing cavities; the water outflow body is disposed at a bottom of the water distributor and is provided with a plurality of water outlets for sprinkling water from the shower; the massage water rotor is in rotational sleeve joint with the water outflow body and is located between the water distributor and the water outflow body; the decorative cover is disposed on an outer side of the water outflow body, and is provided with through holes in sleeve joint with the plurality of the water outlets in a one-to-one correspondence manner, and the decorative cover can drive the water outflow body to rotate relative to the water distributor such that each of the water outlets communicates with one or all of the water distributing cavities.
